(19) United States
(12) Patent Application Publication
(10) Pub. No.: US 2018/0191448 A1
(43) Pub. Date: Jul. 5, 2018

(54) Adaptive Nonlinear Compensation In Direct Detect Optical Transmission

(71) Applicant: Alcatel-Lucent USA Inc., Murray Hill, NJ (US)

(72) Inventors: Noriaki Kaneda, Westfield, NJ (US); Sian Chong J. Lee, Summit, NJ (US)

(73) Assignee: Alcatel-Lucent USA Inc., Murray Hill, NJ (US)

(21) Appl. No.: 15/718,954

(22) Filed: Sep. 28, 2017

Related U.S. Application Data
(60) Provisional application No. 62/440,784, filed on Dec. 30, 2016.

(51) Int. Cl. H04B 10/69; H04B 10/079; H04L 27/06

(52) U.S. Cl. CPC H04B 10/6971; H04L 27/06; H04B 10/07953

(57) ABSTRACT

An apparatus includes an optical receiver that includes a processor. The receiver is configured to direct a digital-electrical representation of a received symbol value of a pulse-amplitude modulated signal to a frequency-domain processing path of the processor and to a time-domain processing path of the processor. The processor is configured to compute, in the frequency-domain processing path, a first product of the received symbol value and a first coefficient, and to compute a second product of the received symbol value and a second coefficient. The processor is further configured to compute, in the time-domain processing path, an estimated error metric based on the first and second products, and to determine an updated first coefficient and an updated second coefficient based on said error metric. The processor is further configured to equalize a subsequent received symbol using the updated coefficients.

### CROSS-REFERENCE TO RELATED APPLICATIONS

This application claims priority from U.S. Provisional Patent Application Ser. No. 62/440,784 filed on 30 Dec. 2016.

### TECHNICAL FIELD

The present invention relates generally to the field of optical communications, and more particularly, but not exclusively, to direct detection optical receivers.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Pulse-amplitude modulation (PAM), and more specifically PAM4, has proven useful in optical communications application for transmitting 50-Gb/s per wavelength channel and higher. While the effective transmission distance of PAM format is typically limited to about 10 km, the format is relatively inexpensive to implement and sufficient for many purposes, e.g. intra-urban or data center communications. While the transmission range may be extended, e.g. to greater than about 40 km, by use of a dispersion compensation module (DCM) or by dispersion shifted fibers, DCM-free standard single mode fiber transmission generally is preferred for flexible and versatile deployment of the system. Furthermore, it remains a challenge for module designers to simultaneously meet the requirement of dispersion tolerance and the simple architecture of direct detection.

### SUMMARY

Disclosed herein are various embodiments of apparatus and methods that may be beneficially applied to, e.g., reception of a pulse-amplitude modulation (PAM) optical signal in optical communications applications. While such embodiments may be expected to provide improvements in performance and/or reduction of cost of such apparatus and methods relative to conventional implementations, no particular result is a requirement of the present invention unless explicitly recited in a particular claim.

In an example embodiment, e.g. a method, a digital-electrical representation of a received symbol sequence is directed to a frequency-domain processing path of a processor, e.g. of an optical receiver. The digital-electrical representation is also directed to a time-domain processing path of the processor. The received symbols may comprise sequential values of a pulse-amplitude modulated (PAM) signal. A first product of a received symbol value and a first coefficient, and a second product of a squared value of the received symbol value and a second coefficient, are computed in the frequency-domain processing path. In the time-domain processing path, an error metric is estimated based on the first and second products, and an updated first coefficient and an updated second coefficient are determined based on the error metric.

In some embodiments the updated first coefficient and the updated second coefficient are determined based on the error metric and a time-delayed representation of the received symbol value. In some embodiments the error metric is determined as a squared difference between a decided value of the received symbol value and a sum of the first and second products. In some embodiments further include performing a frequency-domain computation to determine the squared value. In some embodiments the pulse-amplitude modulated signal is a single-sideband (SSB) PAM4 signal. In some embodiments the digital-electrical representation includes two samples of each received symbol value.

Various embodiments provide a non-transitory processor-readable medium having embodied therein executable program code that when executed by a processor causes the processor perform any one or more of the preceding methods.

Further embodiments provide an apparatus, e.g. a PAM optical receiver. The apparatus includes an optical receiver configured to direct a digital-electrical representation of a received symbol value of, e.g. a PAM signal, to a frequency-domain processing path of a processor and to a time-domain processing path of the processor. The processor is configured to compute, in the frequency-domain processing path, a first product of a first coefficient and the received symbol value, and to compute a second product of a second coefficient and a squared value of the received symbol value. The processor is further configured to compute, in the time-domain processing path, an estimated error metric based on the first and second products, and to determine an updated first coefficient and an updated second coefficient based on the error metric. The processor may then equalize a subsequent received signal using the updated coefficients.

In various embodiments the updated first coefficient and the updated second coefficient are determined based on a time-delayed representation of the received symbol value and the error metric. In some embodiments the error metric is determined as a squared difference between a decided value of the received symbol value and a sum of the first and second products. In some embodiments the error metric is computed based on a first sample of the received symbol value, and a second sample of the received symbol value is equalized using the updated first coefficient and the updated second coefficient. In some embodiments the updated first coefficient and the updated second coefficient are determined based on a time-delayed representation of the squared value. In some embodiments the PAM signal is a single-sideband (SSB) PAM4 signal. In some embodiments the digital-electrical representation includes two samples of each received symbol value.

Other embodiments provide additional methods, e.g. of manufacturing a PAM optical receiver according to any of the preceding apparatuses.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 provides a simplified block diagram illustrating selected components of a PAM transmitter and receiver, and an optical fiber path therebetween, wherein the receiver is configured according to one or more embodiments;

FIG. 2 provides a simplified block diagram of computational functions performed by a processor, e.g. a DSP, in the receiver of FIG. 1;

FIG. 3 provides a computational block diagram of a method embodiment that may be performed by the processor of FIG. 1, e.g. performed in the time domain;

FIG. 4 provides a computational block diagram of a method embodiment that includes a time domain computational path and a frequency domain computational path;

FIG. 5 provides a computational block diagram of an alternate method embodiment, in which a number of discrete Fourier transforms performed is reduced relative to the embodiment of FIG. 4;

FIG. 6 presents data gathered from an experimental system, such as the system illustrated in FIG. 1, and illustrates a reduced bit-error ratio (BER) that may be produced by some embodiments; and

FIGS. 7A and 7B present histogram and convergence plots of received symbol streams determined from the experimental system, before (7A) and after (7B) transmission over an 80 km span of optical fiber.

### DETAILED DESCRIPTION

High baud rate PAM4 chipsets, as well as the single side band (SSB) PAM4 and 80 km WDM transmission have recently been demonstrated. See, e.g. S. Shahramian, et al., “A 112 Gb/s 4-PAM Transceiver Chipset in 0.18 μm SiGe BiCMOS Technology for Optical Communication Systems,” in Proc. IEEE CSICS, pp. 1-4, October 2015, and J. Lee, et al., “112-Gbit/s Intensity-Modulated Direct-Detect Vestigial-Sideband PAM4 Transmission over an 80-km SSMF Link,” in Proc. ECOC 2016, M.2.D.3, pp. 1-3, September 2016, both of which are incorporated herein in their entireties. Other promising studies support the feasibility of a 112-Gb/s PAM4 transceiver DSP despite the complexity of advanced equalization techniques such as maximum likelihood sequence estimation (MLSE). See, e.g. N. Stojanovic, et al. “Performance and DSP Complexity Evaluation of a 112-Gbit/s PAM-4 Transceiver Employing a 25-GHz TOSA and ROSA,” in Proc. ECOC 2015, ID 0102, pp. 1-3, September 2015, incorporated herein in its entirety. However, further improvements are needed, e.g. reduced power consumption by the DSP. The inventors have recognized that power consumption may be advantageously reduced by employing more efficient signal processing techniques in nonlinear distortion reduction algorithms implemented in the DSP.

Various embodiments described herein disclose such efficient signal processing in the nonlimiting context of a PAM4 receiver. Such embodiments provide effective compensation of component nonlinearity, and some embodiments have demonstrated significant gain improvements of SSB-PAM4 transmission over an 80 km span.

A technical problem that persists with the direct detection (DD) scheme is nonlinear distortion of the detected signal. The nonlinearity can originate from one or more of multiple sources in the signal path, including nonlinearity of electro-optical modulators, detectors, and/or other components. In the case of SSB modulation, the primary source of nonlinearity is generally considered to be signal-to-signal beating of the detected signal. Such nonlinearity typically reduces the maximum transmission distance possible without exceeding a specified BER.

Embodiments consistent with this disclosure are expected to reduce the penalty incurred by such nonlinearity, thereby increasing the maximum transmission distance for a given BER. Embodiments include an optical communication transmission system, an optical receiver, and a processing device, and methods of forming and using such systems, receivers and processing devices. Such embodiments are expected to be of particular advantage in so-called “metro” optical transmission systems, e.g. with an end-to-end transmission distance up to about 80 km, in which low-cost optical reception is possible and desired.

The following Figures and description provide details of various embodiments, wherein like reference numerals are used to refer to like elements throughout. In summary, the frequency-selective square term of the signal (sometimes referred to as signal-signal beating), generated by square law detection at the receiver photodiode, is treated as the dominant contribution of the nonlinear distortion, while other square terms and high-order terms are disregarded. Using least mean square (LMS)-based error criteria, coefficients of a receiver nonlinear equalizer are determined using an adaptive equalizer scheme. Experimental data are presented without limitation showing a demonstrable improvement of transmission performance using nonlinear equalization as described.

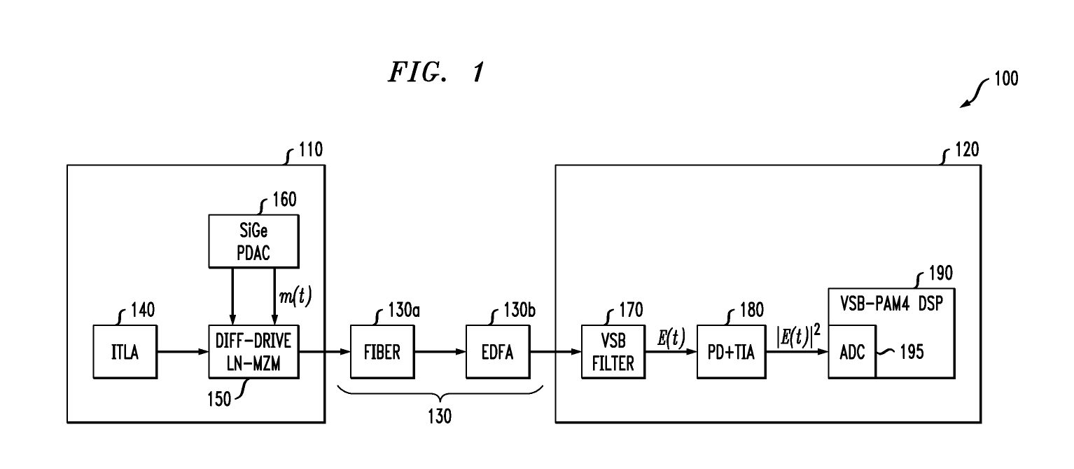

FIG. 1 is a schematic diagram of a system 100, e.g. a metro optical communication link, configured to operate consistent with embodiments of the disclosure. The system includes a transmitter 110, a receiver 120, and an optical link 130 connected therebetween. The transmitter 110 includes an optical source 140, e.g. an ITLA (integrable tunable laser assembly), and a modulator 150, e.g. a differential-drive MZM (Mach-Zehnder modulator). The modulator 150 also receives a drive signal m(t) from a data source 160, e.g. a PDAC (power digital-to-analog converter) configured to produce a PAM4-modulated drive signal, and directs the modulated optical signal toward the optical link 130. The optical link 130 may include an optical fiber 130a and an amplifier 130b, e.g. an EDFA (erbium-doped fiber amplifier). The fiber 130a may have a length up to about 80 km, e.g. as generally applicable to metro optical communication links, but is not limited to any particular length.

The receiver 120 receives the modulated optical signal via an input filter, e.g. a VSB (vestigial sideband) filter 170, which directs a filtered optical-domain signal E(t) to an optical-to-electrical (OE) transducer 180. The transducer 180, which may include a photodiode (PD) and a trans-impedance amplifier (TIA), converts the signal E(t) by square-law detection to an electrical-domain modulated signal |E(t)|². A receiver processor 190, e.g. a DSP, receives the output of the transducer 180 via an ADC 195 that converts the electrical-domain modulated signal to a digital-electrical representation of received symbol values, e.g. PAM4 symbols.

The output of the filter 170 may be represented by Eq. 1 below, which includes a single side-band (SSB) signal component:

$$E ( t ) = \{ 1 + α \underbrace{[ m ( t ) + j \hat{m} ( t ) ]}_{SSB signal} \} \cdot {e}^{j {ω}_{o} t} , for 0 < α \leq 0.5 \qquad ( 1 )$$

where m(t) is the drive signal to the modulator 150;

\hat{m}(t) is the Hilbert transform of m(t);

ωₒ is the optical carrier frequency; and

1/α^{def}=the carrier-to-signal ratio.

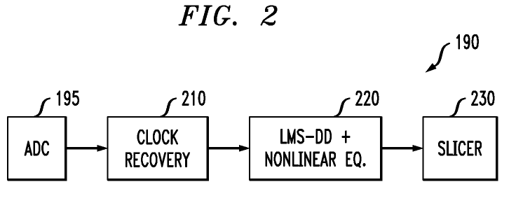

FIG. 2 provides for illustration purposes one possible embodiment of the receiver processor 190, including the ADC 195, a clock recovery block 210, a signal processor block 220, and a slicer 230. In various embodiments the receiver processor 190 is configured to implement instructions for direct detection of PAM-N modulation, e.g. PAM4, where N represents the number of discrete amplitude levels that may be used to encode a data symbol. The block 210 receives the digital-electrical representation of |E(t)|² from the ADC 195 and may perform conventional clock-recovery functions known to those skilled in the pertinent art. The signal processor 220 performs LMS direct-detection and nonlinear equalization of the converted received signal, that again may be conventional functions known to those skilled in the pertinent art. The slicer 230, e.g. a comparator, resolves any signal level ambiguity in the output of the signal processor 220. The slicer 230 may also operate conventionally, though embodiments are not so limited.

The |E(t)|² signal output by the transducer 180, may also be expressed as the product of the received signal E(t) and the complex conjugate of the received signal, E*(t). As illustrated by Eq. 2 below, after expansion and collection of terms, the electrical-domain modulated signal includes the signal component [m²(t)+j\hat{m}²(t)], which represents nonlinear distortion of the received signal due to signal-to-signal beating of the detected signal.

$$\begin{matrix}{\vert E ( t ) \vert}^{2} = E ( t ) \cdot {E}^{*} ( t ) \\ = \{ 1 + α [ m ( t ) + j \hat{m} ( t ) ] \} \cdot {e}^{j {ω}_{o} t} \cdot \\ \{ 1 + α [ m ( t ) - j \hat{m} ( t ) ] \} \cdot {e}^{- j {ω}_{o} t} \\ = 1 + 2 α m ( t ) + {α}^{2} \underbrace{[ {m}^{2} ( t ) + {\hat{m}}^{2} ( t ) ]}_{NL Distortion}\end{matrix} \qquad ( 2 )$$

Conventionally, feed-forward equalization (FFE) may be expressed by Eq. 3, where x(k) is a sequence of symbols with index k received by the processor 190, y(k) is a corresponding sequence of equalized symbols, and n is an index denoting the FIR filter coefficient, and.

y(k)=Σcₙ·xₙ(k) (3)

When the signal-signal beat term due to square-law detection is included, the corrected symbol stream may be represented as

y(k)=Σcₙ·xₙ(k)+Σhₙ·xₙ²(k) (4)

In Eq. 4, cₙ is an n^{th} coefficient of the linear FFE term, and hₙ is an n^{th} coefficient of the nonlinear (squared) FFE term. This expression is similar to a Volterra expansion, but with only the most dominant terms included to reduce computational complexity. Limiting the nonlinear terms to the self-squared terms has the advantageous effect of reducing the complexity of computations performed in the frequency domain.

Herein and in the claims, the self-squared term of xₙ may be referred to as the “second-order term” of xₙ. Any self-multiple of xₙ greater than second-order, e.g. xₙ³, xₙ⁴, . . . , may be referred to as a “higher-order term” of xₙ.

Eq. 5 provides an LMS error term that may be used in an update of the linear and nonlinear coefficients, where ŷ represents one of the decided N-levels of the received PAM symbols, e.g. 4 levels.

ε=|ŷ(k)−y(k)|² (5)

The linear coefficient cₙ may be determined via the following relation,

$$\begin{matrix}{c}_{n} ( k ) = {c}_{n} ( k - 1 ) + {μ}_{1} \frac{d ɛ}{{dc}_{n}} \\ = {c}_{n} ( k - 1 ) + 2 {μ}_{1} ( \hat{y} ( k - d ) - y ( k - d ) ) \cdot x ( k - d )\end{matrix} \qquad ( 6 )$$

and the nonlinear coefficient hₙ may be determined via the following relation,

$$\begin{matrix}{h}_{n} ( k ) = {h}_{n} ( k - 1 ) + {μ}_{2} \frac{d ɛ}{{dh}_{n}} \\ = {h}_{n} ( k - 1 ) + 2 {μ}_{2} ( \hat{y} ( k - d ) - y ( k - d ) ) \cdot {x}^{2} ( k - d )\end{matrix} \qquad ( 7 )$$

where μ₁ and μ₂ are adjustable convergence factors of the error term with respect to cₙ and hₙ, respectively; and

d is a delay value described in greater detail below.

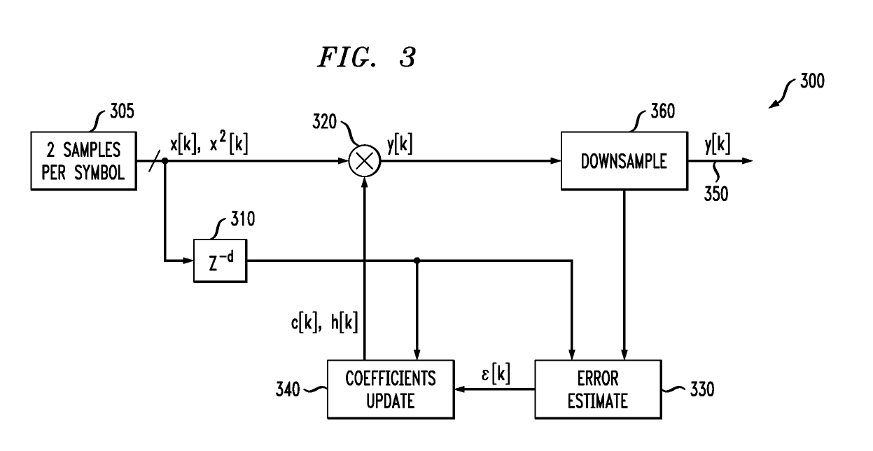

FIG. 3 illustrates functional blocks of a signal processing architecture, or algorithm, 300 that may be used to implement a portion of the processor 220 in one embodiment consistent with the preceding discussion. More specifically, the architecture 300 presents a time-domain implementation.

A sampler 305 receives a symbol stream . . . S[k−1], S[k], S[k+1] . . . and provides sample streams x and x², e.g. from samples obtained by the ADC 195, with specific sample values x(k) and x²(k) corresponding to a k^{th} symbol. In various embodiments the symbol stream is oversampled, e.g. two samples are captured in each symbol period, thus two values of x(k) and two values of x²(k). The oversampling ratio is not limited to 2 and may be relatively close to unity, e.g. a multiple of about 1.1 times the symbol rate.

In the illustrated embodiment, the architecture 300 provides nonlinear equalization of the received sample stream entirely in the time domain. A delay 310 and a multiplication node 320 each receive the x(k) and x²(k) values. The multiplier 320 computes an equalized value y[k] corresponding to the k^{th} sampled symbol, e.g. by applying Eq. 4 using coefficients c[k] and h[k] as described further below. An error estimator 330 and a coefficient updater 340 each receive the delayed values from the delay 310. The error estimator 330 determines an error estimate ε[k], e.g. by applying Eq. 5, using the delayed values and a corresponding y[k] value from the multiplication node 320 via an optional downsampler 360. The coefficient updater 340 determines updated coefficients c[k] and h[k], e.g. by implementing Eq. 6 and Eq. 7, and directs these to the multiplication node 320. The optional downsampler 360 reduces the output symbol rate to, e.g. the same rate as the received sample stream.

Notably, the architecture 300 does not rely on terms of x(k) other than the linear, x(k) and squared, x²(k), terms. In other words, the nonlinear equalization of the received sample stream does not use higher-order terms of x(k), and does not use cross-terms of x(k) and values from other received symbols. This is contrast with other, e.g. some conventional, nonlinear equalization algorithms that use higher-order and/or cross terms, such as the Volterra expansion and derivatives thereof. The reduced terms used in the architecture 300 make possible a substantial reduction in hardware complexity and computational latency of the equalization loop relative to some conventional nonlinear equalization implementations.

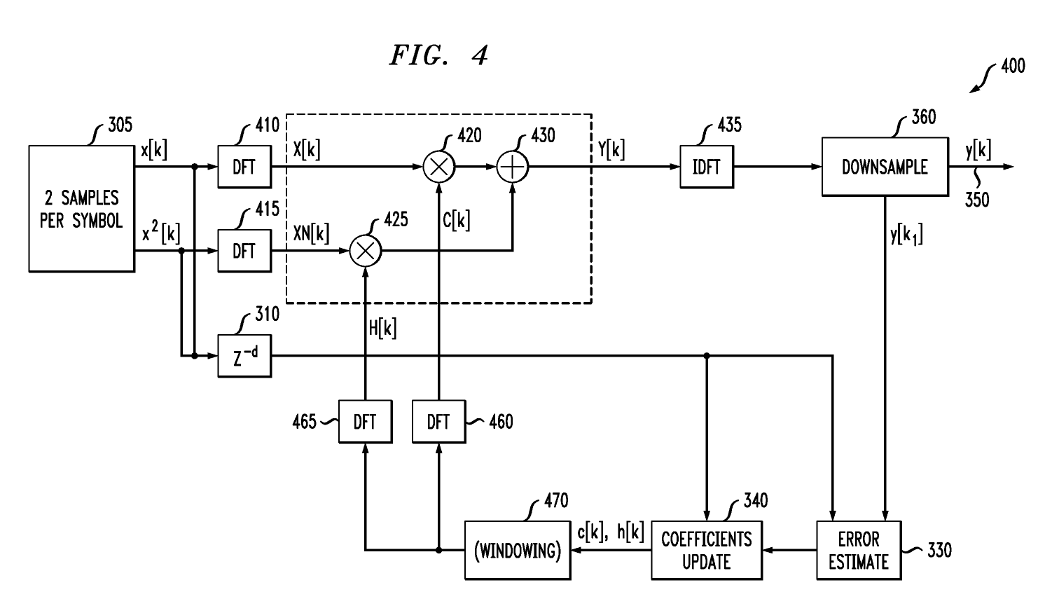

FIG. 4 illustrates functional blocks of a signal processing architecture, or algorithm, 400 that uses a similar computational model as used in the signal processing architecture 300, but wherein a portion of the computational loop is executed in the frequency domain. As described previously, the limited terms of Eq. 4 make this equation well-suited to a frequency domain implementation, which may improve performance, e.g. by reduced latency, and/or reduced hardware requirements. As described in greater detail below, the architecture 400 includes a frequency-domain processing path and a time-domain processing path. As a matter of nomenclature, values within the frequency-domain path are represented with an upper-case variable name, e.g. X, while values within the time-domain path are represented with a lower-case variable name, e.g. x.

In a first computational cycle the sampling module 305 provides sample streams x[k] and x²[k]. Within a frequency-domain portion (dashed lines), a DFT (discrete Fourier Transform) module 410 performs a block-wise frequency-domain conversion of the x[k] sample, where k=1, 2, . . . N, to produce X[n], n=1, 2, . . . N. A DFT module 415 similarly provides a frequency-domain representation of the x²[k] sample, XN[n]. The DFT blocks 410, 415 may preferably include a time domain overlap, which is well-known to those skilled in the pertinent art, e.g. to achieve an “overlap-save” or “overlap-add” scheme to avoid an aliasing penalty. A frequency-domain multiplying node 420 computes a product of X[n] and C[n], wherein C[n] is the frequency-domain representation of c[k]. A frequency-domain multiplying node 425 computes a product of XN[n] and H[n], e.g. the frequency-domain representation of h[k]. In some embodiments, a default or stored value of C and/or H may be used. A frequency-domain summing node 430 combines the results from the nodes 420 and 425 to produce a value Y[n], e.g. a frequency-domain analog of y[k]. An inverse DFT 435 converts Y[n] to the time domain value y[k], which may be predicated on the assumption that the input sequence is oversampled by a factor of two. In embodiments in which the DFT blocks 410, 415 use the time domain overlap, the IDFT 435 may remove the time domain overlap.

The error estimator 330 and coefficient updater 340 may operate as previously described to generate the updated (time domain) values of c[k] and h[k] corresponding to the first sample of the symbol y[2k], which are then converted to the frequency domain values C[n] and H[n] by, respectively, a DFT 460 and a DFT 465 for input to the nodes 420 and 425, respectively. An optional windowing unit 470 may filter the c and h output by the updater 340 to limit the time window of the data input to the DFTs 460, 465.

In a second computational cycle, the second samples x[k] and x²[k] are respectively converted to frequency domain values X[n] and X²[n] by the DFTs 410, 415, which are presented to the nodes 420 and 425, which with the updated values C[n] and H[n], produces a corrected frequency-domain symbol Y[n] at the output of the summing node 430. This value is converted to the time-domain by the IDFT 435, which thus outputs a stream of Y[n] values that may be down-sampled by the optional down-sampler 360 as previously described.

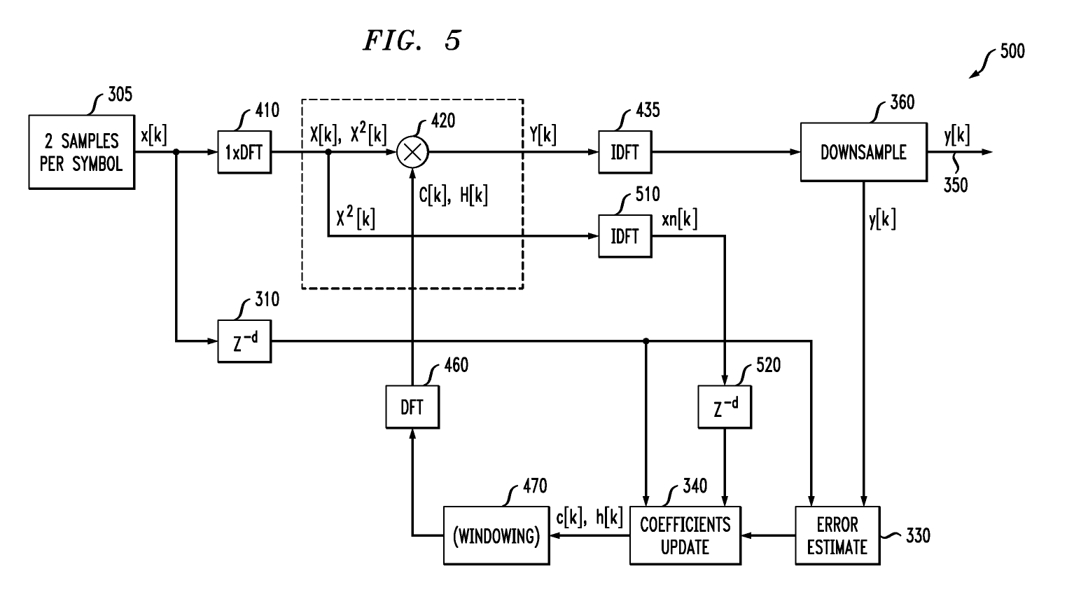

FIG. 5 illustrates functional blocks of a signal processing architecture, or algorithm, 500 that further refines the approach used in the architecture 400 of combining time-domain and frequency-domain portions of the coefficient update loop. In this embodiment, only a single DFT 410 is used, which not only converts the sampled data stream to the frequency domain, but also computes X²[n] in the frequency domain. An IDFT 510 converts the X²[n] stream to a time-domain stream xn[k] which may be aligned as needed by a delay 520 with data from the error estimator 330. The coefficient updater 340 receives both the xn[k] data stream and the x[k] data stream, and computes the updated values in the time domain, as described previously. Those skilled in the pertinent art will recognize the necessary modifications of Eqs. 6 and 7 to compute the c and h values using x[k] and xn[k]. This approach is based on the assumption that the nonlinear term is dominated by the frequency-selective term X²[k].

Those skilled in the art of signal processing will recognize that the functional blocks of FIGS. 3-5 may be implemented in one of many different techniques, e.g. a digital signal processor, e.g. that may be implemented by a circuit that include various transistor-level gates (NAND, XOR, etc.) that may be configured to implement specific functions, modules, and/or state machines. The steps of any algorithm within the scope of the disclosure, such as those algorithms represented by FIGS. 3-5, may be embodied as executable program code stored in or on a non-transitory medium, which may further be readable by the processor. For the purpose of this disclosure, algorithm steps implemented directly in circuitry, e.g. transistor-level logical functions, are considered to be stored on or in a non-transitory medium. Furthermore, when such algorithm steps are implemented directly in circuitry of the processor, masks used in the fabrication of such circuitry are also considered to store the steps on or in a non-transitory medium.

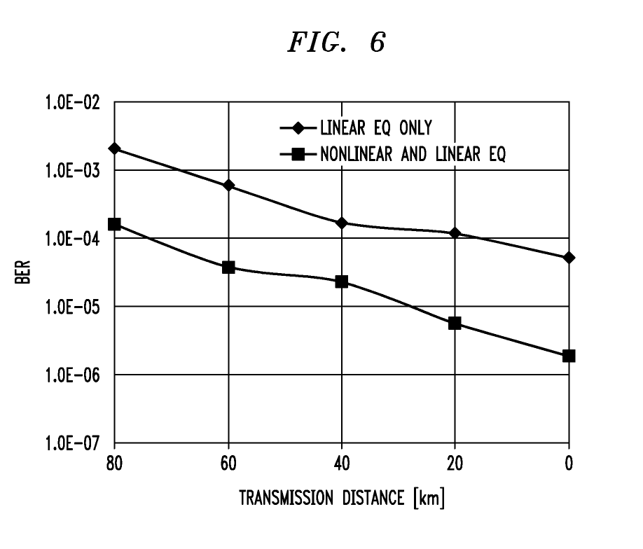

Turning to FIG. 6, illustrated is a chart exemplifying the performance of one or more embodiments within the scope of the disclosure in an experimental system such as that shown in FIG. 1. In FIG. 6, the bit error rate (BER) is displayed as a function of decreasing transmission distance. The upper characteristic (diamonds) denotes the performance of the experimental system using linear equalization only (e.g. omitting the squared term in Eq. (4). The lower characteristic (squares) denotes the performance of the experimental system using linear and self-square equalization, e.g. as described by Eq. (4). The BER in both characteristics decreases with about a same slope on this log-linear scale, but the lower characteristic has a BER about an order of magnitude lower than the upper characteristic. Viewed another way, for a hypothetical system specification of 1.0E-04 BER, the system of the upper characteristic (linear equalization only) would be limited to about 20 km transmission distance, while the system of the lower characteristic (linear plus self-square equalization) would be capable of transmitting about 75 km.

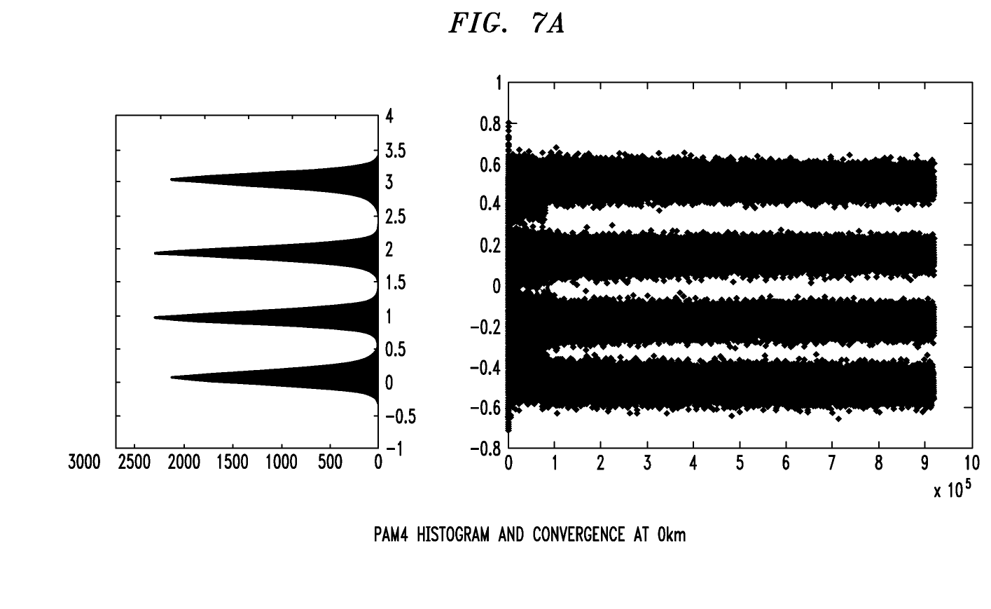

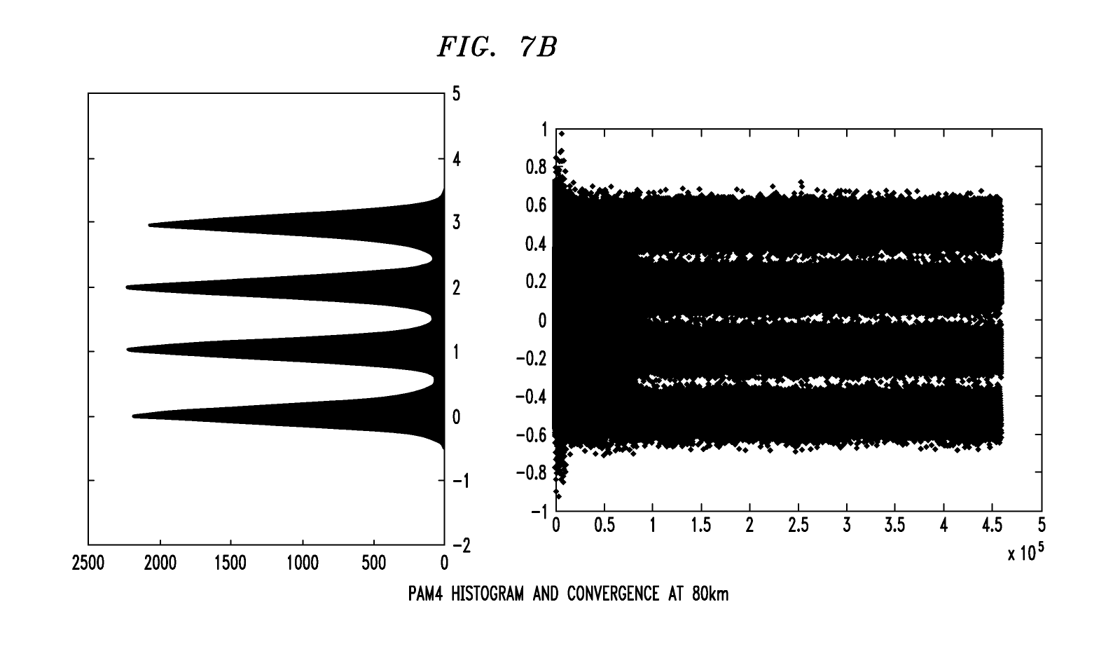

FIG. 7A illustrates a histogram and convergence of received symbol values for the experimental system at 0 km transmission distance, while FIG. 7B shows a similar histogram and convergence at 80 km transmission distance. In both cases the receiver converges in fewer than about 8E5 symbols. While the noise floor is, as expected, higher at 80 km, the histograms show a similarly tight distribution for both cases, further confirming the utility of the described embodiments.

The experimental results of FIGS. 6 and 7A, 7B clearly show a significantly large improvement of performance with a relatively small increase of complexity of the equalization system. Moreover, the small increase in complexity desirably limits the increase of power dissipation by the processor. While the power increase associated with various described embodiments may be as much as 2 to 2.5 times larger than compared to linear compensation alone, implementation of a full Volterra series would be expected to result in a power increase on the order of at least about 10 times, even with a limited number of terms. Thus, embodiments consistent with the disclosure provide performance improvement similar to the implementation of a Volterra series, using only about 25% of the power that full implementation of the Volterra series would require,

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

1. A method, comprising:
directing to a frequency-domain processing path of a processor, and to a time-domain processing path of the processor, a digital-electrical representation of a received symbol sequence comprising sequential values of a pulse-amplitude modulated (PAM) signal;
in said frequency-domain processing path, computing a first product of a received symbol value and a first coefficient, and computing a second product of a squared value of said received symbol value and a second coefficient; and
in said time-domain processing path, estimating an error metric based on said first and second products, and determining an updated first coefficient and an updated second coefficient based on said error metric.

2. The method of claim 1, wherein said updated first coefficient and said updated second coefficient are determined based on said error metric and a time-delayed representation of said received symbol value.

3. The method of claim 1, wherein said error metric is determined as a squared difference between a decided value of said received symbol value and a sum of said first and second products.

4. The method of claim 1, further comprising performing a frequency-domain computation to determine said squared value.

5. The method of claim 1, wherein said pulse-amplitude modulated signal is a single-sideband (SSB) PAM4 signal.

6. The method of claim 1, wherein said digital-electrical representation includes two samples of each received symbol value.

7. A non-transitory processor-readable medium having embodied therein executable program code that when executed by a processor causes the processor perform the method of claim 1.

8. A method of manufacturing an optical receiver, comprising:
configuring an optical receiver to direct a digital-electrical representation of a received optical symbol value of a pulse-amplitude modulated signal to a frequency-domain processing path of a receiver processor and to a time-domain processing path of said receiver processor;
configuring said receiver processor to compute, in said frequency-domain processing path, a first product of a first coefficient and said received symbol value, and to compute a second product of a second coefficient and a squared value of said received symbol value; and
configuring said processor to compute, in said time-domain processing path, an estimated error metric based on said first and second products, and to determine an updated first coefficient and an updated second coefficient based on said error metric.

9. The method of claim 8, wherein said updated first coefficient and said updated second coefficient are determined based on said error metric and a time-delayed representation of said received symbol value.

10. The method of claim 8, wherein said error metric is determined as a squared difference between a decided value of said received symbol value and a sum of said first and second products.

11. The method of claim 8, wherein said error metric is computed based on a first sample of said received symbol value, and a second sample of said received symbol value is equalized using said corrected first coefficient and said corrected second coefficient.

12. The method of claim 8, wherein said first and second products are computed in the frequency-domain processing path, and further comprising determining in said time domain processing path said corrected first coefficient and said corrected second coefficient based on a time-delayed representation of said squared value.

13. The method of claim 8, wherein said digital-electrical representation includes two samples of each received symbol value.

14. An apparatus, comprising:
an optical receiver configured to direct a digital-electrical representation of a received optical symbol value of a pulse-amplitude modulated signal to a frequency-domain processing path of a processor and to a time-domain processing path of said processor,
the processor configured to:
compute, in said frequency-domain processing path, a first product of said received symbol value and a first coefficient, and to compute a second product of said received symbol value and a second coefficient;
compute, in said time-domain processing path, an estimated error metric based on said first and second products, and to determine an updated first coefficient and an updated second coefficient based on said error metric; and
equalize a subsequent received signal using the updated coefficients.

15. The apparatus of claim 14, wherein the updated first coefficient and the updated second coefficient are determined based on said error metric and a time-delayed representation of said received symbol value.

16. The apparatus of claim 14, wherein said error metric is determined as a squared difference between a decided value of said received symbol value and a sum of said first and second products.

17. The apparatus of claim 14, wherein said error metric is computed based on a first sample of said received symbol value, and a second sample of said received symbol value is equalized using the updated first coefficient and the updated second coefficient.

18. The apparatus of claim 14, wherein said the updated first coefficient and the updated second coefficient are determined in said time domain processing path based on a time-delayed representation of said squared value.

19. The apparatus of claim 14, wherein said pulse-amplitude modulated signal is a single-sideband (SSB) PAM4 signal.

20. The apparatus of claim 14, wherein said digital-electrical representation includes two samples of each received symbol value.
